(19) United States
(12) Patent Application Publication
(10) Pub. No.: US 2025/0350454 A1
(43) Pub. Date: Nov. 13, 2025

(54) PRIVACY PROTECTION FOR A-IOT DEVICE IDENTIFIERS

(71) Applicant: Intel Corporation, Santa Clara, CA (US)

(72) Inventor: Abhijeet Ashok Kolekar, Hillsboro, OR (US)

(21) Appl. No.: 19/272,971

(22) Filed: Jul. 17, 2025

Related U.S. Application Data
(60) Provisional application No. 63/673,042, filed on Jul. 18, 2024.
(60) Provisional application No. 63/673,045, filed on Jul. 18, 2024.

(51) Int. Cl. H04L 9/08; H04L 9/06; H04W 12/02

(52) U.S. Cl. CPC H04L 9/0894; H04L 9/0643; H04L 9/0866; H04W 12/02

(57) ABSTRACT

An apparatus and system for privacy protection for Ambient Internet-of-Things (A-IoT) devices are disclosed. A-IoT devices transmit obfuscated identifiers (OIDs) instead of actual identifiers, which are de-obfuscated by the network to retrieve the original identifiers. The device identifiers are obfuscated using shared secret parameters and periodically updated configurations. Hash-based lightweight privacy mechanisms, temporary identifiers (TempIDs), and pseudonym generation may be used to ensure secure communication and prevent replay attacks.

### PRIORITY CLAIM

This application claims the benefit of priority to U.S. Provisional Patent Application Ser. No. 63/673,042, filed Jul. 18, 2024, and U.S. Provisional Patent Application Ser. No. 63/673,045, filed Jul. 18, 2024, each of which is incorporated herein by reference in its entirety.

### TECHNICAL FIELD

Embodiments pertain to wireless networks and wireless communications. Some embodiments relate to Ambient Internet of Things (A-IoT) systems.

### BACKGROUND

Mobile communication has evolved significantly from early voice systems to highly sophisticated integrated communication platform. Next-generation (NG) wireless communication systems, including 5th generation (5G) and sixth generation (6G) or new radio (NR) systems, are to provide access to information and sharing of data by various user equipment (UEs) and applications. NR is to be a unified network/system that is to meet vastly different and sometimes conflicting performance dimensions and services driven by different services and applications. As such, the complexity of such communication systems, as well as interactions between elements within a communication system, has increased. In particular, A-IoT devices have been introduced to reduce device size and power consumption for a myriad of uses. However, a number of issues remain to be resolved for A-IoT communications.

### BRIEF DESCRIPTION OF THE DRAWINGS

The present disclosure is illustrated by way of example and not limitation in the figures of the accompanying drawings, in which like references indicate similar elements and in which:

FIG. 1A illustrates an architecture of a network, according to some examples.

FIG. 1B illustrates a non-roaming 5G system architecture, according to some examples.

FIG. 1C illustrates a non-roaming 5G system architecture, according to some examples.

FIG. 2 illustrates a block diagram of a communication device, according to some examples.

FIG. 3 illustrates A-IoT device identifier (ID) obfuscation, according to some examples.

FIG. 4 illustrates hash-based lightweight A-IoT device ID privacy, according to some examples.

FIG. 5 illustrates temporary identifier use to protect A-IoT device ID privacy, according to some examples.

FIG. 6 illustrates A-IoT device ID protection during initial registration, according to some examples.

FIG. 7 illustrates temporary identifier use to protect A-IoT device ID privacy, according to some examples.

FIG. 8 illustrates temporary identifier use to protect A-IoT device ID privacy, according to some examples.

FIG. 9 illustrates ambient A-IoT device ID privacy, according to some examples.

### DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in or substituted for, those of other embodiments. Embodiments outlined in the claims encompass all available equivalents of those claims.

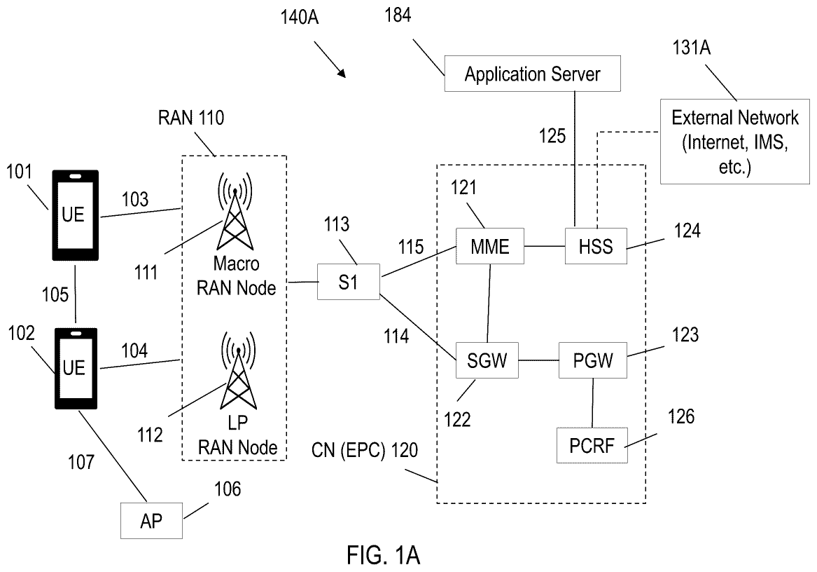

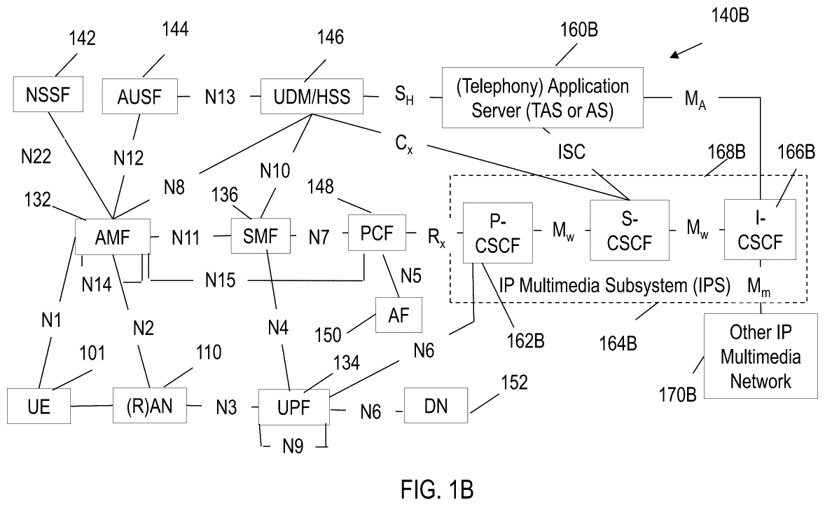

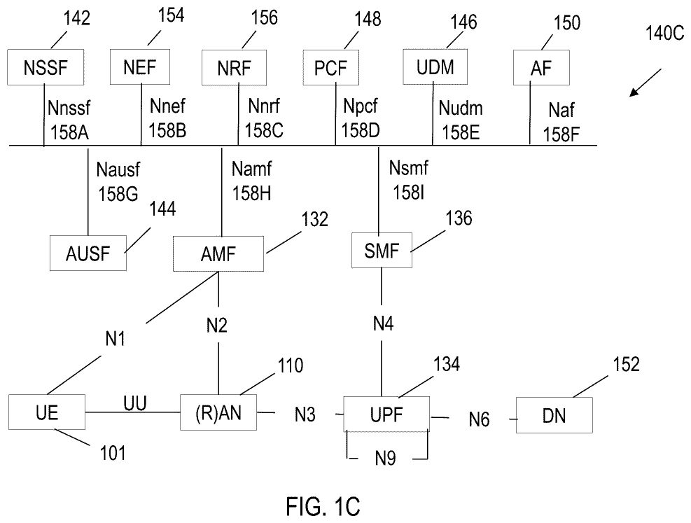

FIG. 1A illustrates an architecture of a network in accordance with some aspects. The network 140A includes 3GPP LTE/4G and NG network functions that may be extended to 6G functions. Accordingly, although 5G will be referred to, it is to be understood that this is to extend as able to 6G structures, systems, and functions. A network function may be implemented as a discrete network element on a dedicated hardware, as a software instance running on dedicated hardware, and/or as a virtualized function instantiated on an appropriate platform, e.g., dedicated hardware or a cloud infrastructure.

The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as portable (laptop) or desktop computers, wireless handsets, drones, or any other computing device including a wired and/or wireless communications interface. The UEs 101 and 102 may be collectively referred to herein as UE 101, and UE 101 may be used to perform one or more of the techniques disclosed herein.

Any of the radio links described herein (e.g., as used in the network 140A or any other illustrated network) may operate according to any exemplary radio communication technology and/or standard. Any spectrum management scheme including, for example, dedicated licensed spectrum, unlicensed spectrum, (licensed) shared spectrum (such as Licensed Shared Access (LSA) in 2.3-2.4 GHZ, 3.4-3.6 GHz, 3.6-3.8 GHZ, and other frequencies and Spectrum Access System (SAS) in 3.55-3.7 GHz and other frequencies). Different Single Carrier or Orthogonal Frequency Domain Multiplexing (OFDM) modes (CP-OFDM, SC-FDMA, SC-OFDM, filter bank-based multicarrier (FBMC), OFDMA, etc.), and in particular 3GPP NR, may be used by allocating the OFDM carrier data bit vectors to the corresponding symbol resources.

In some aspects, any of the UEs 101 and 102 can comprise an Internet-of-Things (IoT) UE or a Cellular IoT (CIT) UE, which can comprise a network access layer designed for low-power IoT applications utilizing short-lived UE connections. In some aspects, any of the UEs 101 and 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network. In some aspects, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN.

The UEs 101 and 102 utilize connections 103 and 104, respectively, each of which comprises a physical communications interface or layer (discussed in further detail below); in this example, the connections 103 and 104 are illustrated as an air interface to enable communicative coupling, and may be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a 5G protocol, a 6G protocol, and the like.

In an aspect, the UEs 101 and 102 may further directly exchange communication data via a ProSe interface 105. The ProSe interface 105 may alternatively be referred to as a sidelink (SL) interface comprising one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), and a Physical Sidelink Feedback Channel (PSFCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable the connections 103 and 104. These access nodes (ANs) may be referred to as base stations (BSs), NodeBs, evolved NodeBs (eNBs), Next Generation NodeBs (gNBs), RAN nodes, and the like, and can comprise ground stations (e.g., terrestrial access points) or satellite stations providing coverage within a geographic area (e.g., a cell). In some aspects, the communication nodes 111 and 112 may be transmission/reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and may be the first point of contact for the UEs 101 and 102. In some aspects, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the nodes 111 and/or 112 may be a gNB, an eNB, or another type of RAN node.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the CN 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VOIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A may be an IoT network or a 5G or 6G network, including 5G new radio network using communications in the licensed (5G NR) and the unlicensed (5G NR-U) spectrum. One of the current enablers of IoT is the narrowband-IoT (NB-IoT). Operation in the unlicensed spectrum may include dual connectivity (DC) operation and the standalone LTE system in the unlicensed spectrum, according to which LTE-based technology solely operates in unlicensed spectrum without the use of an “anchor” in the licensed spectrum, called MulteFire. Further enhanced operation of LTE systems in the licensed as well as unlicensed spectrum is expected in future releases and 5G systems. Such enhanced operations can include techniques for sidelink resource allocation and UE processing behaviors for NR sidelink V2X communications.

An NG system architecture (or 6G system architecture) can include the RAN 110 and a 5G core network (5GC) 120. The NG-RAN 110 can include a plurality of nodes, such as gNBs and NG-eNBs. The CN 120 (e.g., a 5G core network/5GC) can include an access and mobility function (AMF) and/or a user plane function (UPF). The AMF and the UPF may be communicatively coupled to the gNBs and the NG-eNBs via NG interfaces. More specifically, in some aspects, the gNBs and the NG-eNBs may be connected to the AMF by NG-C interfaces, and to the UPF by NG-U interfaces. The gNBs and the NG-eNBs may be coupled to each other via Xn interfaces.

In some aspects, the NG system architecture can use reference points between various nodes. In some aspects, each of the gNBs and the NG-eNBs may be implemented as a base station, a mobile edge server, a small cell, a home eNB, and so forth. In some aspects, a gNB may be a master node (MN) and NG-eNB may be a secondary node (SN) in a 5G architecture.

FIG. 1B illustrates a non-roaming 5G system architecture in accordance with some aspects. In particular, FIG. 1B illustrates a 5G system architecture 140B in a reference point representation, which may be extended to a 6G system architecture. More specifically, UE 102 may be in communication with RAN 110 as well as one or more other 5GC network entities. The 5G system architecture 140B includes a plurality of network functions (NFs), such as an AMF 132, session management function (SMF) 136, policy control function (PCF) 148, application function (AF) 150, UPF 134, network slice selection function (NSSF) 142, authentication server function (AUSF) 144, and unified data management (UDM)/home subscriber server (HSS) 146.

The UPF 134 can provide a connection to a data network (DN) 152, which can include, for example, operator services, Internet access, or third-party services. The AMF 132 may be used to manage access control and mobility and can also include network slice selection functionality. The AMF 132 may provide UE-based authentication, authorization, mobility management, etc., and may be independent of the access technologies. The SMF 136 may be configured to set up and manage various sessions according to network policy. The SMF 136 may thus be responsible for session management and allocation of IP addresses to UEs. The SMF 136 may also select and control the UPF 134 for data transfer. The SMF 136 may be associated with a single session of a UE 101 or multiple sessions of the UE 101. This is to say that the UE 101 may have multiple 5G sessions. Different SMFs may be allocated to each session. The use of different SMFs may permit each session to be individually managed. As a consequence, the functionalities of each session may be independent of each other.

The UPF 134 may be deployed in one or more configurations according to the desired service type and may be connected with a data network. The PCF 148 may be configured to provide a policy framework using network slicing, mobility management, and roaming (similar to PCRF in a 4G communication system). The UDM may be configured to store subscriber profiles and data (similar to an HSS in a 4G communication system).

The AF 150 may provide information on the packet flow to the PCF 148 responsible for policy control to support a desired QoS. The PCF 148 may set mobility and session management policies for the UE 101. To this end, the PCF 148 may use the packet flow information to determine the appropriate policies for proper operation of the AMF 132 and SMF 136. The AUSF 144 may store data for UE authentication.

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162B, a serving CSCF (S-CSCF) 164B, an emergency CSCF (E-CSCF) (not illustrated in FIG. 1B), or interrogating CSCF (I-CSCF) 166B. The P-CSCF 162B may be configured to be the first contact point for the UE 102 within the IM subsystem (IMS) 168B. The S-CSCF 164B may be configured to handle the session states in the network, and the E-CSCF may be configured to handle certain aspects of emergency sessions such as routing an emergency request to the correct emergency center or PSAP. The I-CSCF 166B may be configured to function as the contact point within an operator's network for all IMS connections destined to a subscriber of that network operator, or a roaming subscriber currently located within that network operator's service area. In some aspects, the I-CSCF 166B may be connected to another IP multimedia network 170B, e.g., an IMS operated by a different network operator.

In some aspects, the UDM/HSS 146 may be coupled to an application server 184, which can include a telephony application server (TAS) or another application server (AS) 160B. The AS 160B may be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some aspects, 5G system architectures may be service-based and interaction between network functions may be represented by corresponding point-to-point reference points Ni or as service-based interfaces.

In some aspects, as illustrated in FIG. 1C, service-based representations may be used to represent network functions within the control plane that enable other authorized network functions to access their services. In this regard, 5G system architecture 140C can include the following service-based interfaces: Namf 158H (a service-based interface exhibited by the AMF 132), Nsmf 158I (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

NR-V2X architectures may support high-reliability low latency sidelink communications with a variety of traffic patterns, including periodic and aperiodic communications with random packet arrival time and size. Techniques disclosed herein may be used for supporting high reliability in distributed communication systems with dynamic topologies, including sidelink NR V2X communication systems.

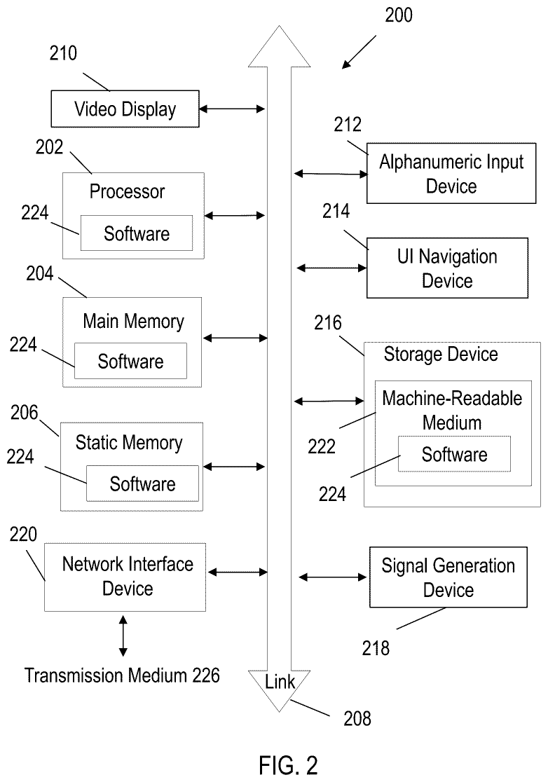

FIG. 2 illustrates a block diagram of a communication device in accordance with some embodiments. The communication device 200 may be a UE such as a specialized computer, a personal or laptop computer (PC), a tablet PC, or a smart phone, dedicated network equipment such as an eNB, a server running software to configure the server to operate as a network device, a virtual device, or any machine capable of executing instructions (sequential or otherwise) that specify actions to be taken by that machine. For example, the communication device 200 may be implemented as one or more of the devices shown in FIGS. 1A-1C. Note that communications described herein may be encoded before transmission by the transmitting entity (e.g., UE, gNB) for reception by the receiving entity (e.g., gNB, UE) and decoded after reception by the receiving entity.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The communication device 200 may include a hardware processor (or equivalently processing circuitry) 202 (e.g., a central processing unit (CPU), a GPU, a hardware processor core, or any combination thereof), a main memory 204 and a static memory 206, some or all of which may communicate with each other via an interlink (e.g., bus) 208. The main memory 204 may contain any or all of removable storage and non-removable storage, volatile memory or non-volatile memory. The communication device 200 may further include a display unit 210 such as a video display, an alphanumeric input device 212 (e.g., a keyboard), and a user interface (UI) navigation device 214 (e.g., a mouse). In an example, the display unit 210, input device 212 and UI navigation device 214 may be a touch screen display. The communication device 200 may additionally include a storage device (e.g., drive unit) 216, a signal generation device 218 (e.g., a speaker), a network interface device 220, and one or more sensors, such as a global positioning system (GPS) sensor, compass, accelerometer, or another sensor. The communication device 200 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a non-transitory machine readable medium 222 (hereinafter simply referred to as machine readable medium) on which is stored one or more sets of data structures or instructions 224 (e.g., software) embodying or utilized by any one or more of the techniques or functions described herein. The non-transitory machine readable medium 222 is a tangible medium. The instructions 224 may also reside, completely or at least partially, within the main memory 204, within static memory 206, and/or within the hardware processor 202 during execution thereof by the communication device 200. While the machine readable medium 222 is illustrated as a single medium, the term “machine readable medium” may include a single medium or multiple media (e.g., a centralized or distributed database, and/or associated caches and servers) configured to store the one or more instructions 224.

The term “machine readable medium” may include any medium that is capable of storing, encoding, or carrying instructions for execution by the communication device 200 and that cause the communication device 200 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

The instructions 224 may further be transmitted or received over a communications network using a transmission medium 226 via the network interface device 220 utilizing any one of a number of wireless local area network (WLAN) transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks. Communications over the networks may include one or more different protocols, such as Institute of Electrical and Electronics Engineers (IEEE) 802.11 family of standards known as Wi-Fi, IEEE 802.16 family of standards known as WiMax, IEEE 802.15.4 family of standards, a Long Term Evolution (LTE) family of standards, a Universal Mobile Telecommunications System (UMTS) family of standards, peer-to-peer (P2P) networks, a next generation (NG)/5th generation (5G) standards among others. In an example, the network interface device 220 may include one or more physical jacks (e.g., Ethernet, coaxial, or phone jacks) or one or more antennas to connect to the transmission medium 226.

Note that the term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single- or multi-core processor, and/or any other device capable of executing or otherwise operating computer-executable instructions, such as program code, software modules, and/or functional processes.

Any of the radio links described herein may operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17) and subsequent Releases (such as Rel. 18, Rel. 19, etc.), 3GPP 5G, 5G, 5G New Radio (5G NR), 3GPP 5G New Radio, 3GPP LTE Extra, LTE-Advanced Pro, LTE Licensed-Assisted Access (LAA), MuLTEfire, UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as 3GPP Generic Access Network, or GAN standard), Zigbee, Bluetooth (r), Wireless Gigabit Alliance (WiGig) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p or IEEE 802.11bd and other) Vehicle-to-Vehicle (V2V) and Vehicle-to-X (V2X) and Vehicle-to-Infrastructure (V2I) and Infrastructure-to-Vehicle (I2V) communication technologies, 3GPP cellular V2X, DSRC (Dedicated Short Range Communications) communication systems such as Intelligent-Transport-Systems and others (typically operating in 5850 MHz to 5925 MHz or above (typically up to 5935 MHz following change proposals in CEPT Report 71)), the European ITS-G5 system (i.e. the European flavor of IEEE 802.11p based DSRC, including ITS-G5A (i.e., Operation of ITS-G5 in European ITS frequency bands dedicated to ITS for safety related applications in the frequency range 5,875 GHz to 5,905 GHz), ITS-G5B (i.e., Operation in European ITS frequency bands dedicated to ITS non-safety applications in the frequency range 5,855 GHz to 5,875 GHZ), ITS-G5C (i.e., Operation of ITS applications in the frequency range 5,470 GHz to 5,725 GHz)), DSRC in Japan in the 700 MHz band (including 715 MHz to 725 MHz), IEEE 802.11bd based systems, etc.

Aspects described herein may be used in the context of any spectrum management scheme including dedicated licensed spectrum, unlicensed spectrum, license exempt spectrum, (licensed) shared spectrum (such as LSA=Licensed Shared Access in 2.3-2.4 GHZ, 3.4-3.6 GHZ, 3.6-3.8 GHz and further frequencies and SAS=Spectrum Access System/CBRS=Citizen Broadband Radio System in 3.55-3.7 GHZ and further frequencies). Applicable spectrum bands include IMT (International Mobile Telecommunications) spectrum as well as other types of spectrum/bands, such as bands with national allocation (including 450-470 MHZ, 902-928 MHz (note: allocated for example in US (FCC Part 15)), 863-868.6 MHz (note: allocated for example in European Union (ETSI EN 300 220)), 915.9-929.7 MHz (note: allocated for example in Japan), 917-923.5 MHz (note: allocated for example in South Korea), 755-779 MHz and 779-787 MHz (note: allocated for example in China), 790-960 MHz, 1710-2025 MHz, 2110-2200 MHz, 2300-2400 MHz, 2.4-2.4835 GHz (note: it is an ISM band with global availability and it is used by Wi-Fi technology family (11b/g/n/ax) and also by Bluetooth), 2500-2690 MHz, 698-790 MHz, 610-790 MHz, 3400-3600 MHZ, 3400-3800 MHZ, 3800-4200 MHz, 3.55-3.7 GHZ (note: allocated for example in the US for Citizen Broadband Radio Service), 5.15-5.25 GHz and 5.25-5.35 GHz and 5.47-5.725 GHz and 5.725-5.85 GHz bands (note: allocated for example in the US (FCC part 15), consists four U-NII bands in total 500 MHz spectrum), 5.725-5.875 GHz (note: allocated for example in EU (ETSI EN 301 893)), 5.47-5.65 GHZ (note: allocated for example in South Korea, 5925-7125 MHz and 5925-6425 MHz band (note: under consideration in US and EU, respectively. Next generation Wi-Fi system is expected to include the 6 GHz spectrum as operating band, but it is noted that, as of December 2017, Wi-Fi system is not yet allowed in this band. Regulation is expected to be finished in 2019-2020 time frame), IMT-advanced spectrum, IMT-2020 spectrum (expected to include 3600-3800 MHZ, 3800-4200 MHZ, 3.5 GHZ bands, 700 MHz bands, bands within the 24.25-86 GHz range, etc.), spectrum made available under FCC's “Spectrum Frontier” 5G initiative (including 27.5-28.35 GHz, 29.1-29.25 GHZ, 31-31.3 GHZ, 37-38.6 GHz, 38.6-40 GHz, 42-42.5 GHz, 57-64 GHz, 71-76 GHZ, 81-86 GHz and 92-94 GHz, etc.), the ITS (Intelligent Transport Systems) band of 5.9 GHZ (typically 5.85-5.925 GHz) and 63-64 GHz, bands currently allocated to WiGig such as WiGig Band 1 (57.24-59.40 GHz), WiGig Band 2 (59.40-61.56 GHz) and WiGig Band 3 (61.56-63.72 GHz) and WiGig Band 4 (63.72-65.88 GHZ), 57-64/66 GHz (note: this band has near-global designation for Multi-Gigabit Wireless Systems (MGWS)/WiGig. In US (FCC part 15) allocates total 14 GHz spectrum, while EU (ETSI EN 302 567 and ETSI EN 301 217-2 for fixed P2P) allocates total 9 GHz spectrum), the 70.2 GHz-71 GHz band, any band between 65.88 GHz and 71 GHz, bands currently allocated to automotive radar applications such as 76-81 GHz, and future bands including 94-300 GHz and above. Furthermore, the scheme may be used on a secondary basis on bands such as the TV White Space bands (typically below 790 MHz) where in particular the 400 MHz and 700 MHz bands are promising candidates. Besides cellular applications, specific applications for vertical markets may be addressed such as PMSE (Program Making and Special Events), medical, health, surgery, automotive, low-latency, drones, etc. applications.

In NR systems, Internet of Things (IoT) has evolved to encompass a diverse range of applications, including smart home, smart city, healthcare monitoring, etc. Various connectivity technologies tailored to IoT requirements have been introduced. In particular, Low Power, Wide-Area (LPWA) Technologies such as Narrowband IoT (NB-IoT) and LTE-M were specified to address the specific needs of low-power devices, extending the battery life of IoT devices and enabling their use in remote or hard-to-reach locations.

Given that existing technologies are unable to meet all the requirements of target use cases such as asset identification, inventory, sensing, etc., A-IoT technology have been developed within 3GPP systems in which the number of connections and/or device density can be orders of magnitude higher than existing 3GPP IoT technologies. The new IoT technology provides complexity and power consumption orders of magnitude lower than the existing 3GPP LPWA technologies and addresses use cases and scenarios that are unable to otherwise be fulfilled based on existing 3GPP LPWA IoT technologies.

A-IoT devices are low complexity, energy-harvesting devices with limited data transfer capabilities. A-IoT devices, however, typically have limited size with limited energy storage. The energy source in A-IoT devices may or may not be replaced or recharged manually. In this case, the output power of an energy harvester in A-IoT devices is typically from 1 μW to a few hundreds of μW. Existing cellular devices may not work well with energy harvesting due to their peak power consumption of higher than 10 mW.

The two topologies may be used for A-IoT applications: topology 1 in which the A-IoT device directly and bidirectionally communicates with a gNB, and topology 2 in which the A-IoT device communicates bidirectionally with an intermediate node (relay, Integrated Access and Backhaul (IAB) node, UE, repeater, etc.) between the A-IoT device and gNB. In some embodiments, the intermediate node may be a reader. A reader is a network entity that serves as an intermediary between the A-IoT devices and the core network; the reader may be, for example, a RAN node such as a gNB, eNB, distributed unit (DU), or transmission reception point (TRP). In topology 1, the communication between the gNB and the A-IoT device includes A-IoT data and/or signalling. In topology 2, the intermediate node transfers A-IoT data and/or signalling between the gNB and the A-IoT device.

In some cases, unauthorized tracking and identification of A-IoT devices through their device identifiers may occur during any communication. Various examples described herein may overcome this issue by cryptographic obfuscation or transformation of device identifiers. The processes herein to obfuscate only the A-IoT device identifier is different from 3GPP communications such as 5G NR as device identifiers (such as the International Mobile Subscriber Identity (IMSI) or International Mobile Equipment Identity (IMEI)) are transformed at the device level before transmission. Instead, the communication channel is encrypted (e.g., using NAS or AS layer encryption). Thus, device identifiers are either sent in the clear (for initial access) or replaced with temporary identifiers, and the communication is encrypted after security establishment. The dynamic, cryptographic obfuscation or transformation of device identifiers at the device level as described herein is not limited to identifier obfuscation during initial registration and public key encryption, instead using a broad, session-by-session or message-by-message transformation.

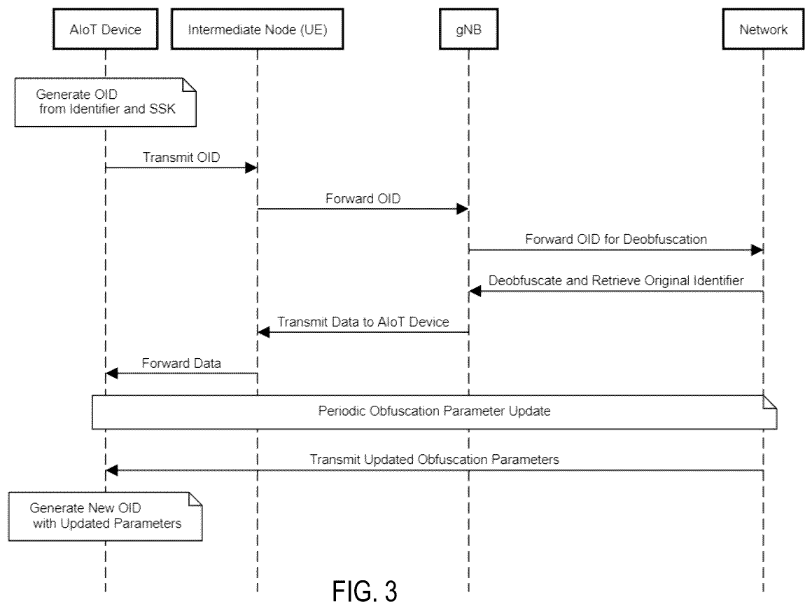

FIG. 3 illustrates A-IoT device ID obfuscation, according to some examples. An A-IoT ID obfuscation mechanism is shown in FIG. 3 to protect A-IoT device IDs and thereby prevent unauthorized tracking and identification while maintaining efficient communication. In this example, A-IoT devices use an obfuscation algorithm to transform their identifiers into pseudo-random sequences before transmission. The obfuscation algorithm is based on a shared secret key (SSK) known only to the device and the network.

The obfuscation algorithm applied by the A-IoT device may be selected from a range of cryptographic primitives, including hash functions (such as SHA-256 or SHA-3), HMAC constructions, or key derivation functions (KDFs) compliant with 3GPP or NIST standards. The choice of algorithm may be influenced by the computational and memory constraints of the A-IoT device. For highly resource-constrained devices, lightweight hash functions or simple bitwise scrambling (such as bit shifting or permutation) may be used, while more capable devices may employ HMAC or KDFs with session keys. The obfuscation algorithm may be parameterized by a device-specific key and a dynamic parameter, ensuring that the output is unique per session or message and unlinkable to a permanent A-IoT identifier.

The parameters for the obfuscation algorithm are periodically updated by the network to ensure continuous security. A-IoT devices synchronize with the network to obtain updated parameters securely.

A-IoT devices transmit obfuscated identifiers (OIDs) instead of actual identifiers. The network uses the SSK and current obfuscation parameters to de-obfuscate the OID and retrieve the original identifier.

A further example focuses on hiding the number of A-IoT devices to prevent the disclosure of sensitive business information, such as the quantity of devices in a specific area. In this case, each A-IoT device is pre-configured with a threshold value for generating response messages. The threshold may be securely provisioned during device setup and can be periodically updated by the 5GC to maintain security.

Inventory triggering and response operations include the reader sending an A-IoT inventory message to the A-IoT devices, which may be triggered by the 5GC. Upon receiving the inventory message, the A-IoT device generates a random number. If the random number is below the threshold (or alternatively above the threshold), the A-IoT device sends two A-IoT messages, each with a different, obfuscated ID. As above, the A-IoT devices use a SSK to generate obfuscated IDs for each response message; the obfuscation algorithm ensures that the obfuscated IDs are unique and not linkable to the original device identifier. Both A-IoT messages are encrypted using the session key (SK) to protect the ID information from unauthorized readers. In some embodiments, multiple thresholds may be used, with the number of A-IoT messages (each with a different, obfuscated ID), being dependent on whether the random number is above or below each threshold.

The random number is typically generated using a device-internal random number generator, and the threshold may be updated by the network as desired. The likelihood of multiple devices generating the same obfuscated identifier in a single operation is minimized by the use of device-specific keys and randomization; however, the network may be equipped to detect and resolve duplicate responses.

Authentication and duplicate detection operations include the reader forwarding both A-IoT messages to the 5GC. The 5GC then decrypts the messages and uses the shared secret key to map the obfuscated IDs to the original device identifier. The 5GC performs authentication and detects any duplicates by comparing the mapped IDs. Only one ID is used for inventory purposes, and the other is discarded.

Similar to the above, the 5GC periodically updates the threshold values securely, ensuring that A-IoT devices remain resilient to tracking attempts. Updates are transmitted securely, with A-IoT devices authenticating the 5GC before accepting new thresholds.

Thus, as shown in FIG. 3, each A-IoT device is provisioned with a permanent device identifier and a SSK during onboarding. The network periodically generates and securely transmits updated obfuscation parameters to the A-IoT device. When the device is ready to transmit, it applies an obfuscation algorithm to its device identifier, using the SSK and the current obfuscation parameters, to generate an OID. The A-IoT device then transmits this OID to the reader or network in place of its permanent identifier. Upon receiving the OID, the network uses the SSK and the current obfuscation parameters to de-obfuscate the OID and recover the original device identifier.

Each A-IoT device is provisioned with one or more cryptographic keys during onboarding. These may include a SSK for obfuscation, a TempID generation key, and an anonymous key (AK) for registration. Keys may be securely provisioned using factory-installed credentials or secure key injection protocols. The network may periodically update or rotate keys to enhance security, and A-IoT devices are configured to accept new keys only from authenticated network entities. In the event of key compromise or suspected desynchronization, the A-IoT device can request re-provisioning or key update from the network. The security protection profile stored on the A-IoT device includes the relevant keys, the obfuscation or T-ID generation algorithm, and any parameters for operation.

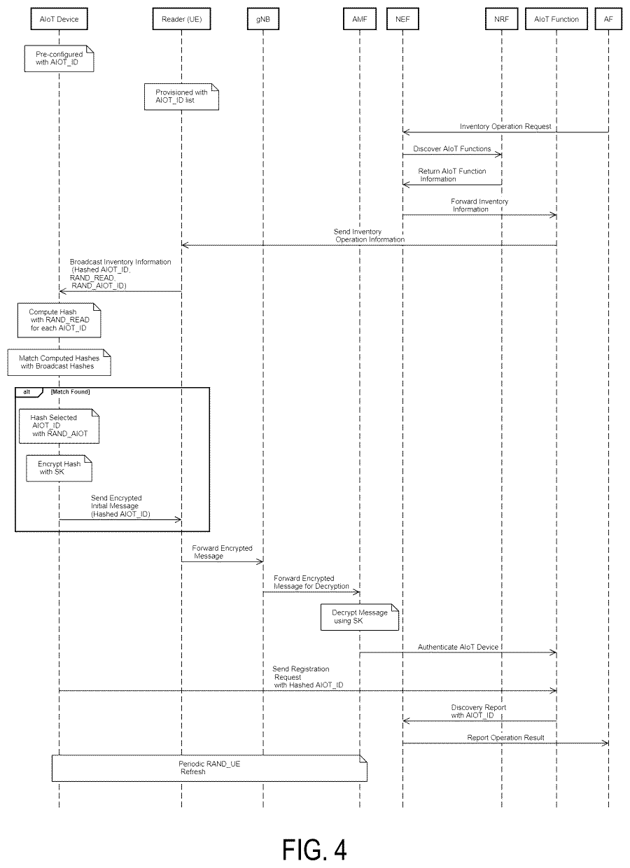

FIG. 4 illustrates hash-based lightweight A-IoT device ID privacy, according to some examples. In this case, the A-IoT devices are pre-configured with a unique A-IoT ID; the readers and intermediate nodes are provisioned with a list of A-IoT IDs. The AF sends an Inventory Operation Request containing target area, client information, and match criteria to the NEF. The NEF authorizes the request, discovers A-IoT functions using the NRF, and forwards inventory information to selected A-IoT functions.

The A-IoT functions subsequently select readers based on the target area and send inventory operation information to the readers. The readers broadcast inventory information, including hashed A-IoT IDs (using RAND_READ as salt), RAND_READ, and RAND_A-IoT_ID.

A-IoT devices compute hashes using RAND_READ for each A-IoT ID. Devices compare computed hashes with broadcasted hashes to find matches. A matching A-IoT ID is selected and further hashed with RAND_A-IoT before being included in an initial message to the network.

The initial message from the A-IoT device to the network contains a hashed and obfuscated A-IoT ID, encrypted using a SK. The encryption ensures confidentiality and integrity protection of the A-IoT ID. RAND_UE, a periodically refreshed random value, is used to salt the hash to prevent replay attacks.

A-IoT devices send a Registration Request containing the encrypted and hashed A-IoT ID. Readers forward Discovery Reports with A-IoT IDs to the AMF/A-IoT AF via intermediate nodes. A-IoT functions report the inventory operation results to the AF through the NEF/AF.

In this example, the broadcast overhead is minimized by using lightweight hashing algorithms and efficient message structures. RAND_READ and RAND_AIOT_ID are periodically refreshed to maintain security without increasing overhead. Each A-IoT device manages a single AIOT_ID, reducing complexity and ensuring efficient operation. The hashing mechanism allows devices to remain anonymous while still participating in inventory operations. Encrypted and hashed messages ensure that unauthenticated paging attempts are mitigated. The use of RAND_UE, which is refreshed periodically, prevents replay attacks and unauthorized tracking. By obfuscating AIOT_IDs and using encryption, device identifiers are effectively protected from unauthorized identification and tracking. The privacy of A-IoT devices during inventory operations is maintained, aligning with the security requirements.

Thus, as shown in FIG. 4, the AF initiates an inventory operation by sending a request to the NEF, specifying the target area, client information, and match criteria. The NEF authorizes the request, discovers A-IoT functions using the NRF, and forwards the inventory information to selected A-IoT functions. These functions select appropriate readers based on the target area and send inventory operation information to the readers. The readers then broadcast inventory information, which includes a list of hashed A-IoT IDs (using a random value RAND_READ as salt), the RAND_READ value, and an additional random value RAND_A-IoT_ID. Each A-IoT device computes hashes using RAND_READ for its own A-IoT ID and compares the result to the broadcasted hashes to determine if it is a target. If a match is found, the device further hashes its A-IoT ID with RAND_A-IoT and prepares an initial message. The device encrypts the hashed and obfuscated A-IoT ID using a SK and includes a periodically refreshed random value (RAND_UE) to salt the hash. The A-IoT device sends a Registration Request containing the encrypted and hashed A-IoT ID to the reader, which forwards a Discovery Report with the A-IoT ID to the AMF/A-IoT AF via intermediate nodes. The A-IoT functions then report the inventory operation results to the AF through the NEF/AF.

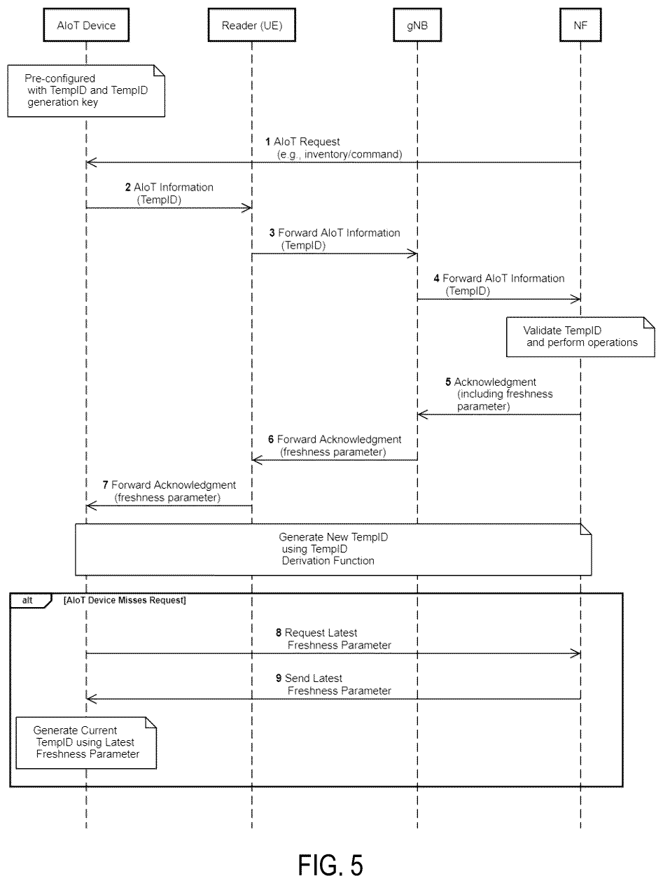

FIG. 5 illustrates temporary identifier use to protect A-IoT device ID privacy, according to some examples. The solution aims to protect AIOT device identifiers by using temporary identifiers (TempID) that are periodically updated. Similar to the last example, A-IoT devices are pre-configured with an initial TempID and TempID generation key during onboarding or registration. Core network functions are also configured with the initial TempID and TempID generation key.

During request and response operations, at step 1, the network sends an A-IoT request (e.g., inventory or command) to the A-IoT device. At step 2, upon receiving the request, the A-IoT device responds with its current TempID. At step 3, the Reader forwards the A-IoT information, including TempID, to the core network. At step 4, the core network uses the TempID to identify the device and perform various operations, verifying the device validity based on TempID and subscription data. At step 5, the core network sends an acknowledgment to the Reader, including a freshness parameter. At step 6, the Reader forwards the acknowledgment, including the freshness parameter, to the A-IoT device. At step 7, both the A-IoT device and the core network generate a new TempID using a TempID derivation function, incorporating the freshness parameter.

To derive the TempID, the derivation function includes a number of input parameters for the KDF. These input parameters include FC: 0xxx; P0: “TempID”; L0: Length of “TempID” (0x00 0x06); P1: Device ID; L1: Length of Device ID; P2: Freshness Parameter; L2: Length of Freshness Parameter. The input key is the TempID generation key (pre-configured in A-IoT device and core network), while the output is the new TempID.

To handle synchronization issues, if the A-IoT device misses a request due to power loss or other issues, recovery steps are implemented. These steps include the A-IoT device maintaining a counter of TempID updates. Upon power restoration, the A-IoT device requests the latest freshness parameter from the network. The network sends the latest freshness parameter, allowing the A-IoT device to generate the current TempID. If multiple updates were missed, the device and network use the counter to determine the correct number of iterations to sync the TempID.

An alternative manner to handle synchronization issues for a device pre-configured with initial TempID and generation key may involve the network sending a request to the A-IoT device. The A-IoT device sends TempID to the Reader, which is then forwarded to the CN. The CN uses TempID for operations and sends an acknowledgment with a freshness parameter. The A-IoT device and CN update TempID using the freshness parameter. If the A-IoT device misses the request, the A-IoT device requests the latest freshness parameter from the network upon regaining power, using the latest freshness parameter to generate the current TempID.

The freshness parameter may be generated by the network entity to maintain operator control and to ensure synchronization across A-IoT devices. This parameter may be a timestamp, a random value, or a session-specific counter for example. The network may securely transmit the updated dynamic parameter to the A-IoT device, either as part of a regular update cycle or in response to specific events such as device re-registration. In some embodiments, the A-IoT device may generate the dynamic parameter locally, but network-generated values may be preferred for consistency and security. If the A-IoT device loses synchronization (for example, due to power loss or missed updates), the A-IoT device may request the current dynamic parameter from the network upon resuming operation. The A-IoT device may maintain a counter of updates to assist in resynchronization, and the network may provide the latest parameter or a sequence of parameters to restore alignment.

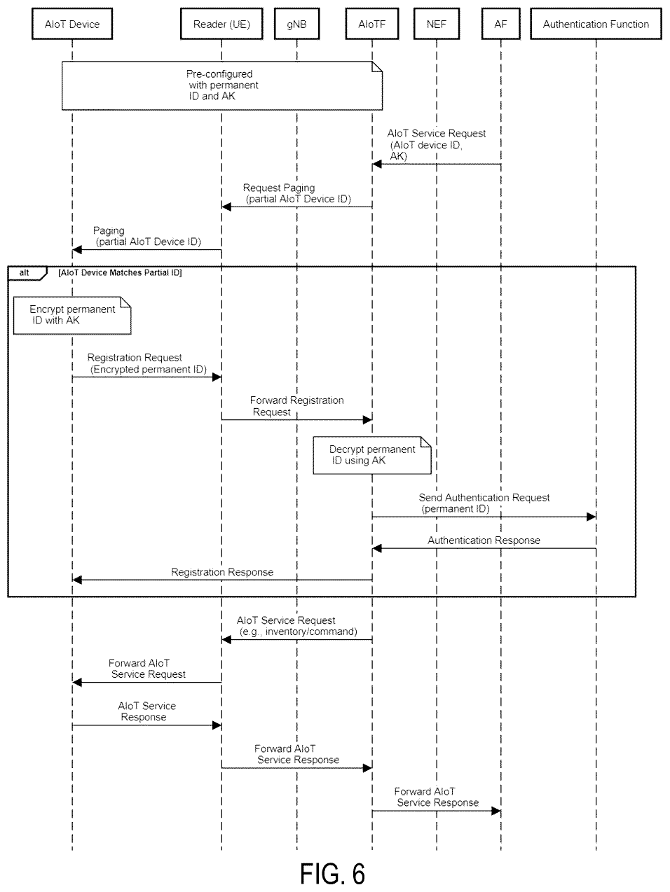

FIG. 6 illustrates A-IoT device ID protection during initial registration, according to some examples. This example provides privacy by protecting AIoT device identifiers during the initial registration process. The process ensures that AIOT device identifiers are not exposed over the air interface by using partial IDs for paging and encrypting permanent IDs with an anonymous key (AK). In this case, mechanisms are provided for identifying the AK and matching individual devices using partial IDs.

A partial device ID is a subset or truncated portion of an AIOT device full identifier. Instead of transmitting the entire AIOT device identifier (such as an IMSI, serial number, or unique device ID), only a segment is used. This segment may be the prefix or a selected set of bits. For example, the IMSI is typically composed of a Mobile Country Code (MCC), Mobile Network Code (MNC), and Mobile Subscriber Identification Number (MSIN). A partial AIOT device identifier might include only the MCC and MNC (e.g., the first 5 or 6 digits), which are common to all devices on a particular network, or the first N digits of the MSIN, which may be shared by a group of devices. Alternatively, for AIOT devices with MAC addresses, a partial identifier could be the Organizationally Unique Identifier (OUI), which is the first 24 bits (first 3 bytes) of the MAC address and identifies the manufacturer. In an A-IoT context, if AIoT devices are assigned identifiers such as A-IoT-XYZ-123456, a partial device identifier could be just the “A-IoT-XYZ” prefix, which is common to a batch or group of devices deployed in a particular region or for a specific customer. If AIoT devices are assigned sequential serial numbers, a partial identifier could be the first several digits, representing a production batch.

The selection of the partial identifier may be based on the desired granularity of paging and privacy. A-IoT devices matching the partial identifier respond by encrypting their permanent identifier with an anonymous key and transmitting the result to the network for further authentication.

During the initial setup operations, at step 0, A-IoT devices are pre-configured with a permanent ID and an AK during onboarding. The AF securely provisions the AK to both the A-IoT device and the A-IoTF.

During paging and partial ID matching operations, at step 1, the AF sends an A-IoT Service Request to the A-IoTF. The A-IoT Service Request includes the A-IoT device ID and the AK. At step 2, the A-IoTF requests the Reader to page A-IoT devices using a partial A-IoT Device ID. The partial ID contains a common part shared by a group of A-IoT devices (e.g., Home Network identifier or 3rd party identifier). At step 3, the Reader broadcasts the paging message with the partial A-IoT Device ID.

During device response and ID protection operations, at step 4, A-IoT devices matching the partial ID perform random access and encrypt their permanent ID with the AK. At step 5, the A-IoT device sends a Registration Request to the A-IoTF. The Registration Request includes the encrypted permanent ID.

During authentication and registration operations, at step 6, the A-IoTF uses the AK to decrypt the A-IoT device permanent ID. At step 7, the A-IoTF sends an authentication request to the A-IoT Authentication Function to verify the device. At step 8, upon successful authentication, the A-IoTF sends a registration response to the A-IoT device.

During the service requests and responses operations, at step 9, the A-IoTF sends subsequent A-IoT Service Requests (e.g., inventory or command) to the Reader. At step 10, the Reader forwards these requests to the A-IoT device. At step 11, the A-IoT device sends service responses back to the Reader. At step 12, the Reader forwards the responses to the A-IoTF. At step 13, the A-IoTF sends the service responses to the AF.

During handling AK identification and partial ID matching operations, the AK is identified through secure provisioning during device onboarding. Partial IDs are matched by broadcasting a common part of the ID that is shared by a group of devices, reducing the risk of exposing full identifiers.

This provides robust protection for AIOT device identifiers by using partial IDs, thereby reducing exposure of full device identifiers by using partial IDs for initial paging. In addition, permanent IDs are encrypted with an AK before transmission. The AK is securely provisioned during device onboarding, preventing unauthorized access. The use of partial IDs and encryption mechanisms ensures that devices can securely and efficiently participate in network operations without exposing sensitive identifiers.

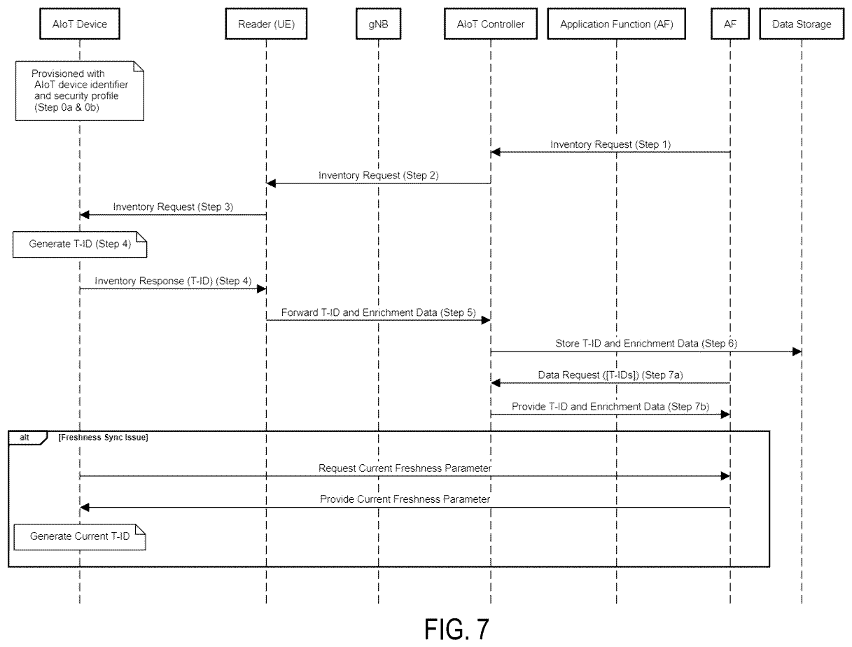

In addition, rather than using static identifiers, pseudo-random sequence device identifiers using a shared secret key may be used, enhancing privacy and security. FIG. 7 illustrates temporary identifier (T-ID) use to protect A-IoT device ID privacy, according to some examples. The AF manages the A-IoT device identifier and the corresponding security protection profile, which includes the device credential and the algorithm used to generate the T-ID. This mechanism is applied when the A-IoT device and AF are provisioned with the security protection profile.

During pre-configuration operations, at step 0a, each A-IoT device is provisioned with its A-IoT device identifier and a security protection profile, which includes a device credential and an algorithm for generating a T-ID. At step Ob, the AF stores the A-IoT device identifier and the associated security protection profile.

During inventory procedure operations, at steps 1-3, the AF triggers an Inventory procedure towards A-IoT devices. At step 4, upon receiving the Inventory Request from the Reader, the A-IoT device generates a new T-ID using the specified algorithm and responds to the Reader. At step 5, the Reader forwards the received T-ID and any enrichment data to the A-IoT Controller. The enrichment data may include information such as the location of the Reader. At step 5, the A-IoT Controller stores the received T-ID and enrichment data. At step 7a, the AF may send a Data Request to the A-IoT Controller, which includes the T-ID(s). At step 7b, the A-IoT Controller provides the T-ID and the associated enrichment data to the AF.

The enrichment data, such as the timestamp of the inventory operation or the location of the reader, may be included with the obfuscated identifier or pseudonym when sent to the network. This data is used for operational purposes, such as device tracking or inventory management, but is protected using encryption and message authentication codes (MACs) to ensure confidentiality and integrity. The session key used for encryption is derived during initial registration or as part of the security profile.

During T-ID Generation and Freshness Synchronization operations, at step 6, a new T-ID is generated using the formula:

$$T - ID = F ( K , freshness parameter , AIoT device identifier )$$

where F is a service-specific function, K is the key provisioned at the A-IoT device, and the freshness parameter is an index or timestamp synchronized between the device and the network. This is one example of a device-specific algorithm, e.g., a cryptographic or transformation function that is uniquely parameterized for each A-IoT device. The device-specific algorithm generates a temporary or obfuscated identifier from the A-IoT device permanent identifier, a cryptographic key, and a freshness parameter. The algorithm may be a hash function, a key derivation function (KDF), or another cryptographic transformation.

For freshness synchronization, the freshness parameter is a timestamp or counter that is synchronized between the A-IoT device and the AF. In case of a synchronization issue (e.g., power loss), the A-IoT device requests the current freshness parameter from the network during re-registration.

For key management, the key K used for deriving the T-ID is a separate temporary key, distinct from the long-term key used for authentication. This temporary key is provisioned during the initial registration and can be periodically updated by the network.

The procedure is designed for individual device identifiers, ensuring unique T-IDs for each A-IoT device. For group-based operations, the partial ID mechanism can be used to trigger responses from multiple devices.

Utilizing a timestamp or counter for the freshness parameter, synchronized between the device and network provides freshness synchronization. In case of desynchronization, a recovery mechanism allows the device to request the current parameter. The key used for T-ID generation is distinct from the long-term authentication key, enhancing security. The use of individual device identifiers ensures unique T-IDs and secure operations.

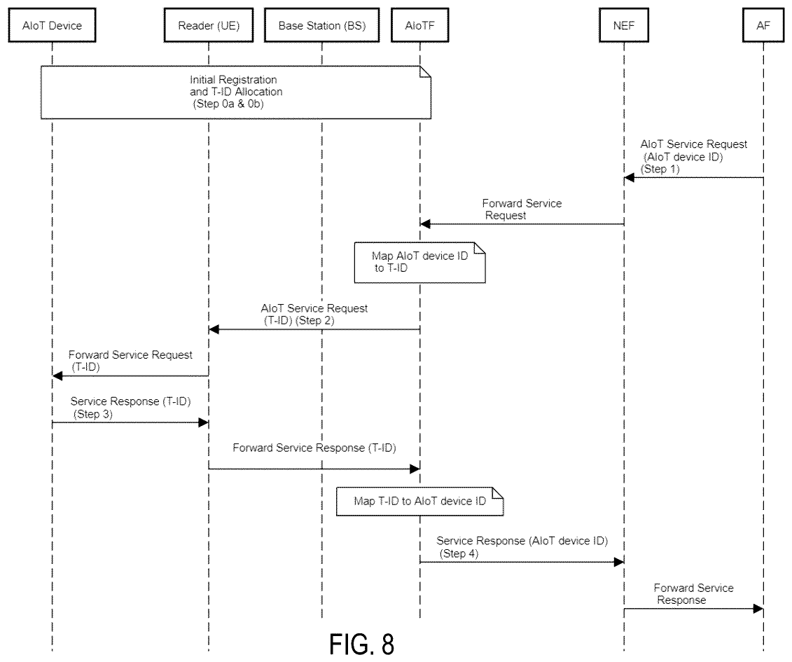

FIG. 8 illustrates temporary identifier use to protect A-IoT device ID privacy, according to some examples. The T-ID provides an unambiguous identification of the A-IoT device without revealing its permanent identity. The A-IoT device T-ID is allocated by the A-IoTF (A-IoT Function) after the A-IoT device's initial registration.

During Initial Registration and T-ID Allocation operations, at step Oa, A-IoT devices undergo initial registration, establishing security contexts with the network. At step Ob, the A-IoTF allocates a T-ID to the A-IoT device and securely transfers the T-ID to the A-IoT device using the established security context.

During Service Request and T-ID Usage operations, at step 1, the AF sends an A-IoT Service Request to the A-IoTF via the NEF. The A-IoT Service Request includes the A-IoT device ID. At step 2, the A-IoTF maps the received A-IoT device ID to the T-ID and uses the T-ID to indicate the specific A-IoT device. The A-IoTF sends the A-IoT Service Request (e.g., Inventory or Command) via the Reader. If only inventory operations are to be used, the A-IoT device can still use this procedure, ensuring that T-ID is used in place of permanent IDs. At step 3, the A-IoT device responds to the A-IoTF via the Reader, including its T-ID. At step 4, the A-IoTF maps the T-ID back to the A-IoT device ID and sends the response to the AF via the NEF.

This procedure can be used by inventory-only A-IoT device devices, ensuring that their T-ID is used instead of their permanent ID during inventory operations. The T-ID is mapped back to the permanent ID only within the network, maintaining the privacy of the A-IoT device in external communications.

The T-ID and any related data exchanged between the A-IoT device and the A-IoTF are encrypted using a SK derived during the initial registration process. The encryption ensures that the T-ID remains confidential during transmission. The integrity of the messages is protected using message authentication codes (MACs) generated with the SK to prevent tampering. The T-ID is generated using a secure algorithm that combines the A-IoT device ID, a freshness parameter (e.g., timestamp or counter), and a device-specific key. The generation formula is:

$$T - ID = F ( K , freshness parameter , A - IoT device ID )$$

where K is the key provisioned at the A-IoT device during initial registration. The freshness parameter is synchronized between the A-IoT device and the network to ensure that each T-ID is unique and valid. In case of a synchronization issue (e.g., power loss), the A-IoT device requests the current freshness parameter from the network during re-registration.

Utilizing T-IDs ensures that temporary identifiers are used instead of permanent identifiers during communication. Allowing inventory-only devices to use the same procedure ensures their privacy. Securing the transmission of T-IDs and related data using encryption and integrity protection mechanisms also ensures privacy. Unique and valid T-IDs are generated through synchronized freshness parameters.

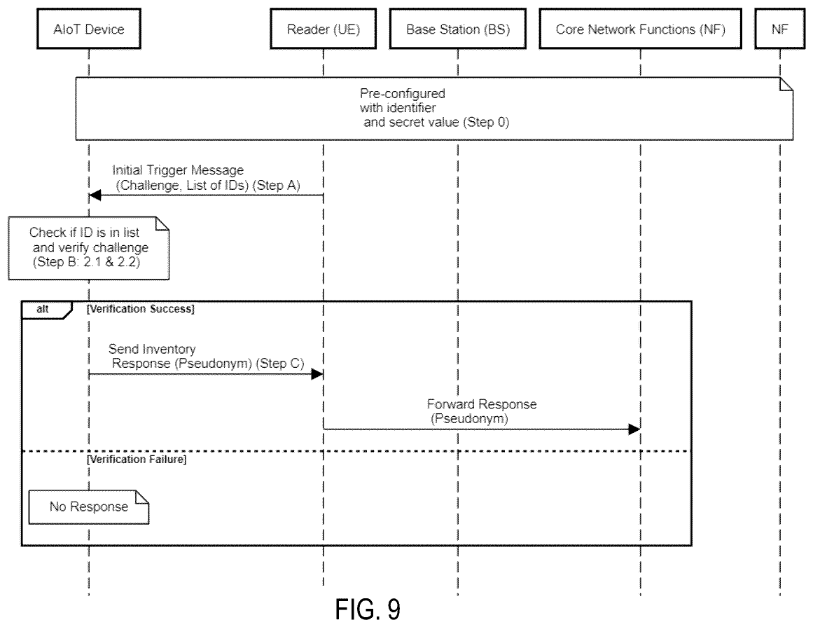

FIG. 9 illustrates ambient A-IoT device ID privacy, according to some examples. FIG. 9 provides a mechanism for verifying requests to share A-IoT device identities and protecting those identities during communication.

During Pre-Configuration operations, at step 0, each A-IoT device is configured with a unique identifier and a secret device-specific value during onboarding.

During Service Request and Initial Trigger Message operations, at step A, based on a service request, the Reader sends an initial trigger message. This message includes: a challenge value to verify the source of the message, and a list of A-IoT identifiers that may be addressed. Due to practical constraints on message size, the list of device IDs is managed efficiently to avoid exceeding RAN-defined limits. This can involve segmenting the list or using hashed identifiers to reduce size.

During Message Verification and Pseudonym Generation operations, at step B, upon receiving the initial trigger message, the A-IoT device may perform several steps. At step 2.1, the A-IoT device checks if its identifier is included in the list of A-IoT identifiers. At step 2.2, the A-IoT device verifies the message source by using the challenge value and its secret device-specific value. If both checks succeed, the A-IoT device generates a pseudonym using its identifier and the received challenge value. This pseudonym ensures the real identity of the A-IoT device is protected. In certain embodiments, the A-IoT device generates a pseudonym by applying a hash function to a combination of its permanent identifier and a challenge value received from the reader or network. The challenge value may be a random number, timestamp, or session-specific value, and its length and format are selected based on device capabilities (e.g., 16, 32, or 64 bits). The hash function may be fixed or configurable, with lightweight options preferred for constrained devices. The pseudonym is unique per session or message and prevents replay or correlation attacks.

During Response with Pseudonym operations, at step C, the A-IoT device sends its pseudonym in the inventory response message to the Reader. The pseudonym is generated using a lightweight hash function to minimize computational overhead.

To address concerns about the practicality of including a list of device IDs in the inventory message, the list of device IDs is segmented into smaller parts or compressed using hash functions to fit within RAN-defined message size limits. In addition, the network dynamically selects which segments of the device ID list to include in each trigger message based on expected device activity and previous responses. The pseudonym and any sensitive data exchanged between the A-IoT device and the Reader are encrypted using a SK derived during the initial registration process. Encryption ensures that the pseudonym remains confidential during transmission. The integrity of the messages is protected using MACs generated with the SK to prevent tampering.

The pseudonym is generated using a secure hash function that combines the A-IoT device's identifier and the challenge value:

$$device identifier valuePseudonym = H ( AIoT device identifier ‖ challenge value ) .$$

The challenge value ensures that each pseudonym is unique and prevents replay attacks. In case of synchronization issues (e.g., power loss), the A-IoT device can request the current challenge value from the network during re-registration.

Utilizing segmented or hashed lists to fit within message size constraints ensures efficient ID management. Dynamically managing the list of device IDs optimizes message size and device response. The transmission of pseudonyms and related data ensures security. Using a hash function to generate pseudonyms minimizes computational overhead on A-IoT devices.

Thus, a dynamic and multi-faceted framework is presented for protecting A-IoT device identifiers from unauthorized tracking and identification. Static device identifiers are replaced by dynamic, non-linkable representations using cryptographic techniques, such as obfuscation algorithms, hash-based mechanisms, T-IDs, and pseudonym generation. These mechanisms are coordinated between the device and the network using shared secrets, periodically updated parameters, and secure provisioning, ensuring that device identifiers transmitted over the air cannot be directly correlated to the original device or persistently tracked.

In some examples, a processor encrypts the obfuscated identifier and associated data using a session key and generates a message authentication code for integrity protection prior to transmission. In some examples, a processor configures the A-IoT to operate in an inventory-only mode such that only obfuscated identifiers are used in all communications and a permanent identifier is never transmitted.

In some examples, the A-IoT device applies an obfuscation algorithm, parameterized by a shared secret key, to its identifier, producing a pseudo-random sequence (obfuscated identifier) for each transmission. The network, possessing the same secret and parameters, reverses the transformation to recover the original identifier. In other examples, a threshold-based response mechanism is used in which each A-IoT device device is pre-configured with a threshold value; upon receiving an inventory request, the A-IoT device generates a random number and, if below the threshold (or alternatively above the threshold), transmits multiple responses with distinct obfuscated identifiers, complicating attempts to infer device population or identity. A further example uses lightweight hash functions, where A-IoT device devices and readers exchange salted hashes of device IDs, enabling matching and registration without exposing the actual identifier. Additional examples employ TempIDs or T-IDs that are periodically updated using key derivation functions and freshness parameters, or allocate T-IDs post-registration, with all communications referencing only the temporary identifier. Another approach leverages partial identifiers for initial paging and encrypts permanent identifiers with an anonymous key during registration, while yet another approach generates pseudonyms by hashing the A-IoT device identifier with a challenge value, ensuring that each response is unique and unlinkable. These embodiments collectively provide a comprehensive set of mechanisms for dynamic, context-aware, and cryptographically robust management of A-IoT device identifiers.

The system may be designed to handle errors such as failed de-obfuscation, key mismatches, or message integrity failures by triggering re-synchronization or re-registration procedures. A-IoT devices may request updated parameters or keys from the network in the event of repeated failures. The privacy mechanisms may be designed to mitigate replay, correlation, and brute-force attacks by ensuring that each identifier is unique per session and unlinkable to previous transmissions. The use of device-specific keys, dynamic parameters, and secure provisioning further enhances resistance to attack.

The disclosed privacy mechanisms are designed to operate alongside existing 3GPP security procedures, such as SUCI and GUTI, but are tailored for A-IoT devices that may lack the resources to implement full 3GPP stacks. Minimum hardware requirements include the ability to perform basic cryptographic operations and maintain secure storage for keys and parameters. Fallback procedures may be implemented for devices unable to perform the required transformations, such as defaulting to group-based or partial identifier responses.

Note that a communication session refers to a logically grouped period of interaction between an A-IoT device and a reader. The communication session may encompass a series of related exchanges or transactions that are treated as a single unit for the purposes of identifier transformation, security context, or protocol state. A session may be initiated by an event such as device registration, inventory operation, or command execution, and may persist for the duration of that operation or until a session-specific parameter (such as a freshness parameter or session key) is updated. A message is a single, discrete unit of data transmitted between the A-IoT device and another entity (such as a reader or network node) within a session. Each message may carry a request, response, or other information, and multiple messages may be exchanged during a single communication session. A session may comprise one or more messages. The dynamic (or freshness) parameter used in the cryptographic transformation may be updated per session (so the same obfuscated identifier is used for all messages in that session) or per message (so each message has a unique obfuscated identifier).

### EXAMPLES

Example 1 is an apparatus for an Ambient Internet-of-Things (A-IoT) device, the apparatus comprising: a memory configured to store an A-IoT device identifier and a cryptographic key; and a processor to configure the apparatus to: generate, for each communication session or message, an obfuscated identifier by applying a cryptographic transformation to the A-IoT device identifier using the cryptographic key and a dynamic parameter that is unique to the communication session or message and periodically updated by a network entity; and transmit the obfuscated identifier in place of the A-IoT device identifier during communication with a reader such that the obfuscated identifier is generated at the A-IoT device for each communication session or message and is not assigned by a network.
In Example 2, the subject matter of Example 1 includes, wherein the processor further configures the apparatus to: receive, from the reader, an update to the dynamic parameter or cryptographic key; and update the obfuscated identifier based on the update.
In Example 3, the subject matter of Examples 1-2 includes, wherein the cryptographic transformation comprises: computing a hash salted with the dynamic parameter, and the processor further configures the apparatus to hash a selected identifier with an additional random value before transmission of the obfuscated identifier to the network.
In Example 4, the subject matter of Examples 1-3 includes, wherein the dynamic parameter comprises a random value generated by the network entity for each communication session or message.
In Example 5, the subject matter of Examples 1˜4 includes, wherein the cryptographic transformation comprises a key derivation function that combines the cryptographic key, the dynamic parameter, and the A-IoT device identifier.
In Example 6, the subject matter of Examples 1-5 includes, wherein the processor further configures the apparatus to generate multiple obfuscated identifiers in response to a single network request, each obfuscated identifier being generated using a different random value or threshold.
In Example 7, the subject matter of Examples 1-6 includes, wherein the processor further configures the apparatus to encrypt the obfuscated identifier using a session key prior to transmission.
In Example 8, the subject matter of Examples 1-7 includes, wherein the processor further configures the apparatus to generate a pseudonym by applying a hash function to a combination of the A-IoT device identifier and a challenge value received from the reader in a trigger message using a secret device-specific value.
In Example 9, the subject matter of Examples 1-8 includes, wherein the processor further configures the apparatus to: use a partial device identifier for initial paging, the partial device identifier comprising a common part shared by a group of A-IoT devices, and encrypt a permanent device identifier with an anonymous key for registration.
In Example 10, the subject matter of Examples 1-9 includes, wherein the processor further configures the apparatus to maintain a counter of updates to the dynamic parameter from the network entity and, upon resuming operation after a power loss, request a current value of the dynamic parameter from the network entity.
In Example 11, the subject matter of Examples 1-10 includes, wherein: the obfuscated identifier is a temporary identifier generated using a device-specific algorithm that is uniquely parameterized for the A-IoT device and a freshness parameter synchronized with the network entity, the freshness parameter being a value that changes over time or per communication session or message, and the processor further configures the apparatus to request a current freshness parameter from the network entity upon detecting a synchronization issue.
In Example 12, the subject matter of Examples 1-11 includes, wherein the processor further configures the apparatus to transmit, in response to an inventory request from a reader, a plurality of messages, each message containing a different obfuscated identifier.
In Example 13, the subject matter of Examples 1-12 includes, wherein the processor further configures the apparatus to, in response to an inventory request from a reader: generate a random number; compare the random number to a predetermined threshold; generate a number of messages dependent on a comparison between the random number and the predetermined threshold; and transmit the number of messages to the reader, each message containing a different obfuscated identifier.
In Example 14, the subject matter of Examples 1-13 includes, wherein the processor further configures the apparatus to periodically update a security protection profile based on instructions received from the network entity, the security protection profile comprising the cryptographic key and a device-specific algorithm that is uniquely parameterized for the A-IoT device and is used to generate the obfuscated identifier.
In Example 15, the subject matter of Examples 1-14 includes, wherein the processor further configures the apparatus to generate the obfuscated identifier using a device-specific key that is distinct from a long-term authentication key.
In Example 16, the subject matter of Examples 1-15 includes, wherein the cryptographic transformation comprises generating a pseudo-random sequence using an obfuscation algorithm that incorporates the cryptographic key as a shared secret key known to the A-IoT device and the network.
Example 17 is an apparatus for a reader in an Ambient Internet-of-Things (A-IoT) system, the apparatus comprising: a memory configured to store information associated with an A-IoT device; and a processor to configure the apparatus to: transmit, to an A-IoT device, an inventory request or trigger message; receive, from the A-IoT device in response to the inventory request or trigger message, an obfuscated identifier generated at the A-IoT device by applying a cryptographic transformation to an A-IoT device identifier using a cryptographic key and a dynamic parameter that is unique to each communication session or message; and forward the obfuscated identifier to a network entity for de-obfuscation and further processing without de-obfuscating the obfuscated identifier.
In Example 18, the subject matter of Example 17 includes, wherein the processor further configures the apparatus to: receive, from the reader, an update to the dynamic parameter or cryptographic key; and update the obfuscated identifier based on the update.
Example 19 is a non-transitory computer-readable storage medium that stores instructions for execution by one or more processors of an apparatus of an Ambient Internet-of-Things (A-IoT) device, the instructions, when executed, cause the A-IoT device to: generate, for each communication session or message, an obfuscated identifier by applying a cryptographic transformation to an A-IoT device identifier using a cryptographic key and a dynamic parameter that is unique to the communication session or message and periodically updated by a network entity; and transmit the obfuscated identifier in place of the A-IoT device identifier during communication with a reader such that the obfuscated identifier is generated at the A-IoT device for each communication session or message and is not assigned by a network.
In Example 20, the subject matter of Example 19 includes, wherein the instructions, when executed, cause the A-IoT device to: receive, from the reader, an update to the dynamic parameter or cryptographic key; and update the obfuscated identifier based on the update.
Example 21 is at least one machine-readable medium including instructions that, when executed by processing circuitry, cause the processing circuitry to perform operations to implement of any of Examples 1-20.
Example 22 is an apparatus comprising means to implement of any of Examples 1-20.
Example 23 is a system to implement of any of Examples 1-20.
Example 24 is a method to implement of any of Examples 1-20.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to indicate one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. As indicated herein, although the term “a” is used herein, one or more of the associated elements may be used in different embodiments. For example, the term “a processor” configured to carry out specific operations includes both a single processor configured to carry out all of the operations as well as multiple processors individually configured to carry out some or all of the operations (which may overlap) such that the combination of processors carry out all of the operations. Further, the term “includes” may be considered to be interpreted as “includes at least” the elements that follow.

The Abstract of the Disclosure is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An apparatus for an Ambient Internet-of-Things (A-IoT) device, the apparatus comprising:
a memory configured to store an A-IoT device identifier and a cryptographic key; and
a processor to:
generate, for a communication session, an obfuscated identifier by applying a cryptographic transformation to the A-IoT device identifier using the cryptographic key and a dynamic parameter that is unique to the communication session or message and periodically updated by a network entity; and
configure the A-IoT device to transmit the obfuscated identifier in place of the A-IoT device identifier during communication with a reader such that the obfuscated identifier is generated at the A-IoT device for the communication session and is not assigned by a network.

2. The apparatus of claim 1, wherein the processor is further to:
configure the A-IoT device to receive, from the reader, an update to the dynamic parameter or cryptographic key; and
update the obfuscated identifier based on the update.

3. The apparatus of claim 1, wherein the processor is further to perform the cryptographic transformation through computation of a hash salted with the dynamic parameter, and use the hash of a selected identifier with an additional random value before transmission of the obfuscated identifier to the network.

4. The apparatus of claim 1, wherein the dynamic parameter comprises a random value generated by the network entity for the communication session.

5. The apparatus of claim 1, wherein the cryptographic transformation comprises a key derivation function that combines the cryptographic key, the dynamic parameter, and the A-IoT device identifier.

6. The apparatus of claim 1, wherein the processor is further to generate multiple obfuscated identifiers in response to a single network request, each obfuscated identifier being generated using a different random value or threshold.

7. The apparatus of claim 1, wherein the processor is further to encrypt the obfuscated identifier using a session key prior to transmission.

8. The apparatus of claim 1, wherein the processor is further to generate a pseudonym by applying a hash function to a combination of the A-IoT device identifier and a challenge value received from the reader in a trigger message using a secret device-specific value.

9. The apparatus of claim 1, wherein the processor is further to:
use a partial device identifier for initial paging, the partial device identifier comprising a common part shared by a group of A-IoT devices, and
encrypt a permanent device identifier with an anonymous key for registration.

10. The apparatus of claim 1, wherein the processor is further to configure the A-IoT device to maintain a counter of updates to the dynamic parameter from the network entity and, upon resuming operation after a power loss, request a current value of the dynamic parameter from the network entity.

11. The apparatus of claim 1, wherein:
the obfuscated identifier is a temporary identifier generated using a device-specific algorithm that is uniquely parameterized for the A-IoT device and a freshness parameter synchronized with the network entity, the freshness parameter being a value that changes over time, per communication session, or per message, and
the processor further configures the A-IoT device to request a current freshness parameter from the network entity upon detecting a synchronization issue.

12. The apparatus of claim 1, wherein the processor further configures the A-IoT device to transmit, in response to an inventory request from a reader, a plurality of messages, each message containing a different obfuscated identifier.

13. The apparatus of claim 1, wherein the processor is further to, in response to an inventory request from a reader:
generate a random number;
compare the random number to a predetermined threshold;
generate a number of messages dependent on a comparison between the random number and the predetermined threshold; and
configure the A-IoT device to transmit the number of messages to the reader, each message containing a different obfuscated identifier.

14. The apparatus of claim 1, wherein the processor is further to periodically update a security protection profile based on instructions received from the network entity, the security protection profile comprising the cryptographic key and a device-specific algorithm that is uniquely parameterized for the A-IoT device and is used to generate the obfuscated identifier.

15. The apparatus of claim 1, wherein:
the processor is further to generate the obfuscated identifier using a device-specific key that is distinct from a long-term authentication key, and
the cryptographic transformation comprises generation of a pseudo-random sequence using an obfuscation algorithm that incorporates the cryptographic key as a shared secret key known to the A-IoT device and the network.

16. The apparatus of claim 1, wherein:
the communication session comprises at least one message, and
the processor is further to generate a different obfuscated identifier for a message in the communication session.

17. An apparatus for a reader in an Ambient Internet-of-Things (A-IoT) system, the apparatus comprising:
a memory configured to store information associated with an A-IoT device; and
a processor to configure the reader to:
transmit, to an A-IoT device, an inventory request or trigger message;
receive, from the A-IoT device in response to the inventory request or trigger message, an obfuscated identifier generated at the A-IoT device by applying a cryptographic transformation to an A-IoT device identifier using a cryptographic key and a dynamic parameter that is unique to a communication session; and
forward the obfuscated identifier to a network entity for de-obfuscation and further processing without de-obfuscating the obfuscated identifier.

18. The apparatus of claim 17, wherein the processor further configures the reader to:
receive, from the reader, an update to the dynamic parameter or cryptographic key; and
update the obfuscated identifier based on the update.

19. A non-transitory computer-readable storage medium that stores instructions for execution by one or more processors of an apparatus of an Ambient Internet-of-Things (A-IoT) device, the instructions, when executed, cause the A-IoT device to:
generate, for a communication session, an obfuscated identifier by applying a cryptographic transformation to an A-IoT device identifier using a cryptographic key and a dynamic parameter that is unique to the communication session and periodically updated by a network entity; and
transmit the obfuscated identifier in place of the A-IoT device identifier during communication with a reader such that the obfuscated identifier is generated at the A-IoT device for the communication session and is not assigned by a network.

20. The non-transitory computer-readable storage medium of claim 19, wherein the instructions, when executed, cause the A-IoT device to:
receive, from the reader, an update to the dynamic parameter or cryptographic key; and
update the obfuscated identifier based on the update.
